(19) United States
(12) Patent Application Publication
(10) Pub. No.: US 2009/0016441 A1
(43) Pub. Date: Jan. 15, 2009

(54) CODING METHOD AND CORRESPONDING CODED SIGNAL

(75) Inventors: Dzevdet Burazerovic, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,711

(22) PCT Filed: Dec. 28, 2004
(86) PCT No.: PCT/IB2004/004313

§ 371 Date: Jun. 22, 2006

(30) Foreign Application Priority Data
Jan. 5, 2004 (EP) 04300005.8

(51) Int. Cl. H04N 7/50

(52) U.S. Cl. 375/240.24; 375/E07.211

(57) ABSTRACT

The invention relates to a coding method applied to digital video data available in the form of a video stream consisting of consecutive frames. These frames, divided into macroblocks, include at least I-frames, independently coded, or P-frames, temporally disposed between said I-frames and predicted from at least a previous I- or P-frame, or B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future. According to the invention, this coding method comprises the following steps: a structuring step, provided for capturing coding parameters characterizing the said weighted prediction; a computing step, for delivering statistics related to said parameters; an analyzing step for determining a change of preference regarding the direction of prediction; a step provided for detecting the occurrences of gradual scene changes; a step provided for generating description data of said occurrences; and a step for encoding the description data thus obtained and the original digital video data.

### FIELD OF THE INVENTION

The invention relates to a coding method for coding digital video data available in the form of a video stream consisting of consecutive frames divided into macroblocks, said frames being coded in the form of at least I-frames, independently coded, or P-frames, temporally disposed between said I-frames and predicted from at least a previous I- or P-frame, or B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future,

The invention also relates to a corresponding encoding device, to corresponding computer-executable process steps provided to be stored on a computer-readable storage medium and comprising the steps defined in said coding method, and to a transmittable coded signal produced by encoding digital-video data according to such a coding method.

### BACKGROUND OF THE INVENTION

More and more digital broadcast services are now available, and it therefore appears as useful to enable a good exploitation of multimedia information resources by users, that generally are not information technology experts. Said multimedia information generally consists of natural and synthetic audio, visual and object data, intended to be manipulated in view of operations such as streaming, compression and user interactivity, and the MPEG-4 standard is one of the most agreed solutions to provide a lot of functionalities allowing to carry out said operations. The most important aspect of MPEG-4 is the support of interactivity by the concept of object, that designates any element of an audio-visual scene: the objects of said scene are encoded independently and stored or transmitted simultaneously in a compressed form as several bitstreams, the so-called elementary streams. The specifications of MPEG-4 include an object description framework intended to identify and describe these elementary streams (audio, video, etc. . . . ) and to associate them in an appropriate manner in order to obtain the scene description and to construct and present to the end user a meaningful multimedia scene: MPEG-4 models multimedia data as a composition of objects. However the great success of this standard contributes to the fact that more and more information is now made available in digital form. Finding and selecting the right information becomes therefore harder, for human users as for automated systems operating on audio-visual data for any specific purpose, that both need information about the content of said information, for instance in order to take decisions in relation with said content.

The objective of the MPEG-7 standard, not yet frozen, will be to describe said content, i.e. to find a standardized way of describing multimedia material as different as speech, audio, video, still pictures, 3D models, or other ones, and also a way of describing how these elements are combined in a multimedia document. MPEG-7 is therefore intended to define a number of normative elements called descriptors D (each descriptor is able to characterize a specific feature of the content, e.g. the color of an image, the motion of an object, the title of a movie, etc. . . . ), description schemes DS (the Description Schemes define the structure and the relationships of the descriptors), description definition language DDL (intended to specify the descriptors and description schemes), and coding schemes for these descriptions. FIG. 1 gives a graphical overview of these MPEG-7 normative elements and their relation. Whether it is necessary to standardize descriptors and description schemes is still in discussion in MPEG. It seems however likely that at least a set of the most widely used will be standardized.

### SUMMARY OF THE INVENTION

It is therefore an object of the invention to propose a new descriptor intended to be very useful in relation with the MPEG-7 standard.

To this end, the invention relates to a coding method such as defined in the introductory part of the description and which is moreover characterized in that it comprises the following steps:
a structuring step, provided for capturing, for all the successive macroblocks of the current frame, related coding parameters characterizing, if any, said weighted prediction;
a computing step, for delivering, for said current frame, statistics related to said parameters;
an analyzing step, provided for analyzing said statistics and determining a change of preference regarding the direction of prediction;
a detecting step, provided for detecting the occurrence of a gradual scene change in the sequence of frames each time a change of preference has been determined;
a description step, provided for generating description data of said occurrences of gradual scene changes;
a coding step, provided for encoding the description data thus obtained and the original digital video data.

The invention also relates to an encoding device for coding digital video data available in the form of a video stream consisting of consecutive frames divided into macroblocks, said frames being coded in the form of at least I-frames, independently coded, or P-frames, temporally disposed between said I-frames and predicted from at least a previous I- or P-frame, or B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future, said encoding device comprising:
structuring means, provided for capturing, for all the successive macroblocks of the current frame, related coding parameters characterizing, if any, said weighted prediction;
computing means, for delivering, for said current frame, statistics related to said parameters;
analyzing means, provided for analyzing said statistics and determining a change of preference regarding the direction of prediction;
detecting means, provided for detecting the occurrence of a gradual scene change in the sequence of frames each time a change of preference has been determined;
description means, provided for generating description data of said occurrences of gradual scene changes;
coding means, provided for encoding the description data thus obtained and the original digital video data.

The invention also relates, for use in an encoding device provided for coding digital video data available in the form of a video stream consisting of consecutive frames divided into macroblocks, said frames being coded in the form of at least I-frames, independently coded, or P-frames, temporally disposed between said I-frames and predicted at least from a previous I- or P-frame, or B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future, to computer-executable process steps provided to be stored on a computer-readable storage medium and comprising the following steps:
a structuring step, provided for capturing, for all the successive macroblocks of the current frame, related coding parameters characterizing, if any, said weighted prediction;
a computing step, for delivering, for said current frame, statistics related to said parameters;
an analyzing step, provided for analyzing said statistics and determining a change of preference regarding the direction of prediction;
a detecting step, provided for detecting the occurrence of a gradual scene change in the sequence of frames each time a change of preference has been determined;
a description step, provided for generating description data of said occurrences of gradual scene changes;
a coding step, provided for encoding the description data thus obtained and the original digital video data.

### BRIEF DESCRIPTION OF THE DRAWINGS

The present invention will now be described, by way of example, with reference to the accompanying drawings in which:

FIG. 1 is a graphical overview of MPEG-7 normative elements and their relation, for defining the MPEG-7 environment in which users may then deploy other descriptors (either in the standard or, possibly, not in it);

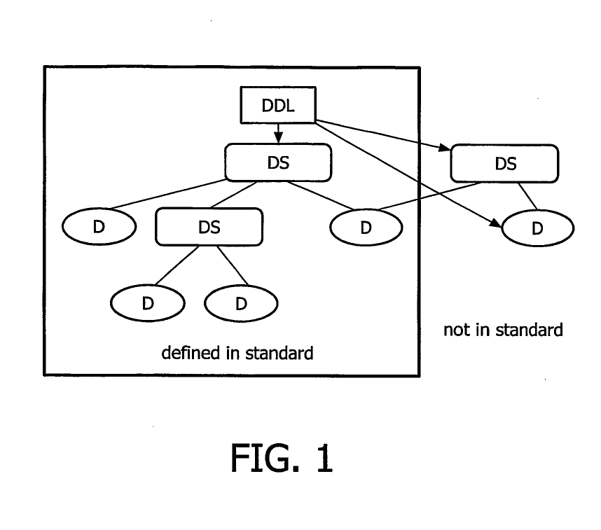

FIGS. 2 and 3 illustrate coding and decoding methods allowing to encode and decode multimedia data.

### DETAILED DESCRIPTION OF THE INVENTION

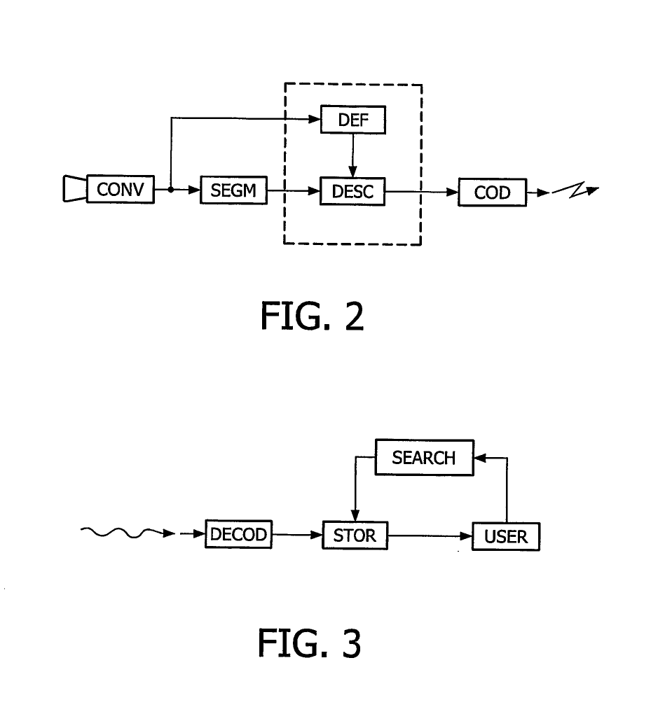

The method of coding a plurality of multimedia data according to the invention, illustrated in FIG. 2, comprises the following steps: an acquisition step (CONV), for converting the available multimedia data into one or several bitstreams, a structuring step (SEGM), for capturing the different levels of information in said bitstream(s) by means of analysis and segmentation, a description step, for generating description data of the obtained levels of information, and a coding step (COD), allowing to encode the description data thus obtained. More precisely, the description step comprises a defining sub-step (DEF), provided for storing a set of descriptors related to said plurality of multimedia data, and a description sub-step (DESC), for selecting the description data to be coded, in accordance with every level of information as obtained in the structuring step on the basis of the original multimedia data. The coded data are then transmitted and/or stored. The corresponding decoding method, illustrated in FIG. 3, comprises the steps of decoding (DECOD) the signal coded by means of the coding method hereinabove described, storing (STOR) the decoded signal thus obtained, searching (SEARCH) among the data constituted by said decoded signal, on the basis of a search command sent by an user (USER), and sending back to said user the retrieval result of said search in the stored data.

Among the descriptors stored in relation with all the possible multimedia content, the one proposed according to the invention is based on the future standard H.264/AVC, which is expected to be officially approved in 2003 by ITU-T as Recommendation H.264/AVC and by ISO/IEC as International Standard 14496-10 (MPEG-4 Part 10) Advanced Video Coding (AVC). This new standard employs quite the same principles of block-based motion-compensated transform coding that are known from the established standards, such as MPEG-2, which indeed use block-based motion compensation as a practical method of exploiting correlation between subsequent pictures in video. This method attempts to predict each macro-block in a given picture by its “best match” in an adjacent, previously decoded, reference picture. If the pixel-wise difference between a macroblock and its prediction is small enough, this difference, or residue, is encoded rather that the macroblock itself. The relative displacement of the prediction with respect to the grid position of the actual MB is indicated by a motion vector, which is coded separately. FIG. 2 illustrates this situation for the case of bi-directional prediction, where two reference pictures are used, one in the past and one in the future (in the display order). Pictures that are predicted in this way are called B-pictures. Otherwise, pictures that are predicted by referring only to the past are called P-pictures.

With H.264/AVC, these basic concepts are further elaborated. Firstly, motion compensation in H.264/AVC is based on multiple reference pictures prediction: a match for a given block can be sought in more distant past or future pictures, instead of only in the adjacent ones. Secondly, H.264/AVC allows to divide a MB into smaller blocks, and to predict each of these blocks separately. This means that the prediction for a given MB can in principle be composed of different sub-blocks, retrieved with different motion vectors and from different reference pictures. The number, size and orientation of the prediction blocks are uniquely determined by the choice of an inter mode. Several such modes are specified, allowing block sizes 16×8, 8×8, etc., down to 4×4. Another innovation in H.264/AVC allows the motion compensated prediction signal to be weighted and offset by amounts specified by the encoder. This means that in the case of a bi-directional prediction concerning a frame B(i) predicted from previous frames P(i−n) and P(i−1) and following frames P(i+j) and P(i+m), the encoder can choose unequal amounts by which the prediction blocks from the past and that from the future will contribute in the total prediction. This feature allows to dramatically improve the coding efficiency for scenes which contain fades.

The problem is however the following one. Owing to the tremendous growth of large digital archives in both the professional and the consumer environment, characterized by a steadily increasing capacity and content variety, finding efficient ways to quickly retrieve stored information of interest is of crucial importance. Search and retrieval in large archives of unstructured video content are usually performed after said content has been indexed using content analysis techniques, based on algorithms such as image processing, pattern recognition and artificial intelligence, which aim at automatically creating annotations of video material (these annotations vary from low-level signal related properties, such as color and texture, to higher level information, such as presence and location of faces).

One of the most important content descriptors is the shot boundary indicator, as seen for instance in a document such as the international patent application WO 01/03429 (PHF99593). A shot is a video segment that has been taken using continuously a single camera, and shots are generally considered as the elementary units constituting a video. Detecting shot boundaries thus means recovering those elementary video units. During video editing, shots are connected using shot transitions, that can be classified into at least two classes: abrupt transitions and gradual transitions. Abrupt transitions, also called hard cuts and obtained without any modifications of the two shots, are fairly easy to detect, and they constitute the majority in all kind of video productions. Gradual transitions, such as fades, dissolves and wipes, are obtained by applying some transformation to the two involved shots. During video production, each transition type is chosen carefully in order to support the content and context of the video sequences. Automatically recovering all their positions and types, therefore, may help a machine to deduce high-level semantics. For instance, in feature films, dissolves are often used to convey a passage of time. Also dissolves occur much more often in feature films, documentaries, biographical and scenic video material than in newscasts, sports, comedy and shows. The opposite is true for wipes. Therefore, the automatic detection of transitions and their type can be used for automatic recognition of video genre.

Because of the large application area for the upcoming H.264/MPEG-4 AVC standard, there will be a growing demand for efficient solutions for H.264/AVC video content analysis. During the recent years, several efficient content analysis algorithms and methods have been demonstrated for MPEG-2 video, that almost exclusively operate in the compressed domain. Most of these methods could easily be extended to H.264/AVC, since H.264/AVC in a way specifies a superset of MPEG-2 syntax, as indicated above. However, due to the limitations of MPEG-2, some of these existing methods may not give adequate (reliable) performance, which is a deficiency that is typically addressed by including additional and often costly methods operating in the pixel or audio domain.

A European patent application filed on the same day as the present one then proposes a method allowing to avoid said drawback. More precisely, said European patent application relates to a method (and the corresponding device) of processing digital coded video data available in the form of a video stream consisting of consecutive frames divided into macroblocks, said frames including at least I-frames independently coded, P-frames temporally disposed between said I-frames and predicted from at least a previous I- or P-frame, and B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future, said processing method comprising the steps of determining for each successive macroblock of the current frame related coding parameters characterizing, if any, said weighted prediction, collecting said parameters for all the successive macroblocks of the current frame, for delivering statistics related to said parameters, analyzing said statistics for determining a change of preference for the direction of prediction, and detecting the occurrence of a gradual scene change in the sequence of frames each time a change of preference has been determined (more precisely, according to said method, the analysis step is provided for comparing the number of macroblocks having the same directional preference and similar weighting against a predefined threshold derived in relation to the total number of macroblocks in the frame, and, moreover, an information about the location and the duration of each scene change is preferably produced and stored in a file).

According to the MPEG-7 standard draft ISO/IEC JTC 1/SC 29 N 4242 (Oct. 23, 2001), tools are specified for describing segments of visual contents created by a video editing work. Video editing work consists in assembling and composing video segments, and the analytic description of such a work corresponds to a hierarchical structure (of three or more levels) of these video segments and the transitions generated during the editing process. The analytic edited video segments are then classified into two categories: the analytic clips (shots, composition shots, intra-composition shots) and the analytic transitions (global transitions, composition transitions, internal transitions). In the normative Annex B of the same document, the type of transition is specified, with a given set of names referring to a predefined MPEG-7 classification scheme (EvolutionTypeCS). The descriptor thus defined for gradual shot transitions may be the one used in the coding method according to the invention in order to generate description data of the occurrences of gradual scene changes.

Indeed as explained above, the motion-compensated prediction in H.264/AVC can be based on prediction blocks from the past and the future that are present in the total prediction by unequal amounts. Because of this inequality, the presence of a gradual shot transition can be indicated by a gradual change in the preference for prediction from one direction to the other, such a change of preference for the direction of prediction being then detected, at the decoding side, by analyzing the statistics of transmitted coding parameters characterizing said weighted prediction (for example, this analysis can include comparing the number of macroblocks having the same directional preference and similar weighting against a given threshold, which could be derived in relation to the total number of macroblocks in the picture, and examining the uniformity of distribution of such macroblocks to make sure that the change in directional preference for prediction is indeed a consequence of a gradual scene transition).

A definition of the coding method according to the invention is then the following. The digital video data to be coded are available in the form of a video stream consisting of consecutive frames divided into macroblocks. These frames are coded in the form of at least I-frames independently coded, or in the form of P-frames temporally disposed between said I-frames and predicted at least from a previous I- or P-frame, or also in the form of B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future. The coding method then comprises the following steps:
a structuring step, provided for capturing, for all the successive macroblocks of the current frame, related coding parameters characterizing, if any, said weighted prediction;
a computing step, for delivering, for said current frame, statistics related to said parameters;
an analyzing step, provided for analyzing said statistics and determining a change of preference regarding the direction of prediction;
a detecting step, provided for detecting the occurrence of a gradual scene change in the sequence of frames each time a change of preference has been determined;
a description step, provided for generating description data of said occurrences of gradual scene changes;
the coding step itself, provided for encoding the description data thus obtained and the original digital video data.

These steps can be implemented, according to the invention, by means of computer-executable process steps stored on a computer-readable storage medium and comprising, more precisely, the steps of:
capturing, for all the successive macroblocks of the current frame, related coding parameters characterizing, if any, said weighted prediction;
delivering, for said current frame, statistics related to said parameters;
analyzing these statistics for determining a change of preference for the direction of prediction;
detecting the occurrence of a gradual scene change in the sequence of frames each time a change of preference has been determined;
   these steps being followed by a description step, provided for generating description data of said occurrences of gradual scene changes, and an associated coding step, provided for encoding the description data thus obtained and the original digital video data.

The invention still relates to an ecoding device allowing to implement these steps and comprising:
structuring means, provided for capturing, for all the successive macroblocks of the current frame, related coding parameters characterizing, if any, said weighted prediction;
computing means, for delivering, for said current frame, statistics related to said parameters;
analyzing means, provided for analyzing said statistics and for determining a change of preference regarding the direction of prediction;
detecting means, provided for detecting the occurrence of a gradual scene change in the sequence of frames each time a change of preference has been determined;
description means, provided for generating description data of said occurrences of gradual scene changes;
coding means, provided for encoding the description data thus obtained and the original digital video data.

The invention finally relates to a transmittable coded signal such as the one available at the output of said encoding device and produced by encoding digital video data according to the coding method previously described.

1. A coding method for coding digital video data available in the form of a video stream consisting of consecutive frames divided into macroblocks, said frames being coded in the form of at least I-frames, independently coded, or P-frames, temporally disposed between said I-frames and predicted from at least a previous I- or P-frame, or B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future, said coding method comprising the following steps:
a structuring step, provided for capturing, for all the successive macroblocks of the current frame, related coding parameters characterizing, if any, said weighted prediction;
a computing step, for delivering, for said current frame, statistics related to said parameters;
an analyzing step, provided for analyzing said statistics and determining a change of preference regarding the direction of prediction;
a detecting step, provided for detecting the occurrence of a gradual scene change in the sequence of frames each time a change of preference has been determined;
a description step, provided for generating description data of said occurrences of gradual scene changes;
a coding step, provided for encoding the description data thus obtained and the original digital video data.

2. An encoding device for coding digital video data available in the form of a video stream consisting of consecutive frames divided into macroblocks, said frames being coded in the form of at least I-frames, independently coded, or P-frames, temporally disposed between said I-frames and predicted from at least a previous I- or P-frame, or B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future, said encoding device comprising:
structuring means, provided for capturing, for all the successive macroblocks of the current frame, related coding parameters characterizing, if any, said weighted prediction;
computing means, for delivering, for said current frame, statistics related to said parameters;
analyzing means, provided for analyzing said statistics and determining a change of preference regarding the direction of prediction;
detecting means, provided for detecting the occurrence of a gradual scene change in the sequence of frames each time a change of preference has been determined;
description means, provided for generating description data of said occurrences of gradual scene changes;
coding means, provided for encoding the description data thus obtained and the original digital video data.

3. For use in an encoding device provided for coding digital video data available in the form of a video stream consisting of consecutive frames divided into macroblocks, said frames being coded in the form of at least I-frames, independently coded, or P-frames, temporally disposed between said I-frames and predicted at least from a previous I- or P-frame, or B-frames, temporally disposed between an I-frame and a P-frame, or between two P-frames, and bidirectionally predicted from at least these two frames between which they are disposed, said predictions of P- and B-frames being performed by means of a weighted prediction with unequal amount of prediction from the past and the future, computer-executable process steps provided to be stored on a computer-readable storage medium and comprising the following steps:
a structuring step, provided for capturing, for all the successive macroblockcs of the current frame, related coding parameters characterizing, if any, said weighted prediction;
a computing step, for delivering, for said current frame, statistics related to said parameters;
an analyzing step, provided for analyzing said statistics and determining a change of preference regarding the direction of prediction;
a detecting step, provided for detecting the occurrence of a gradual scene change in the sequence of frames each time a change of preference has been determined;
a description step, provided for generating description data of said occurrences of gradual scene changes;
a coding step, provided for encoding the description data thus obtained and the original digital video data.

4. A computer program product for a digital video data encoding device, comprising a set of instructions which when loaded into said encoding device lead it to carry out the steps as claimed in claim 3.

5. A transmittable coded signal produced by encoding digital video data according to a coding method as claimed in claim 1.
